(19) United States
(12) Patent Application Publication
(10) Pub. No.: US 2006/0044382 A1
(43) Pub. Date: Mar. 2, 2006

(54) Metal colloid dispersions and their aqueous metal inks

(76) Inventors: Yimin Guan, Lexington, KY (US); Jing X. Sun, Lexington, KY (US); Mark Naiyu Sun, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/925,042

(22) Filed: Aug. 24, 2004

(51) Int. Cl. C09D 11/00; B41J 2/01

(52) U.S. Cl. 347/105; 106/31.6

(57) ABSTRACT

A silver dispersion is obtained by reducing a silver compound in the presence of a polymeric dispersant of an ionic hydrophilic segments, such as methacrylic acid segments con and nonionic hydrophilic segments such as hydroxyl terminated polyethylene glycol segments. Aqueous inkjet inks may contain such dispersants and other common ingredients such as a humectant. The inks can be printed on ceramic substrates and sintered under heat to form solid, conductive patterns of silver.

### TECHNICAL FIELD

This invention relates to colloid dispersions of elemental metal, or its alloy, such as silver, and inks having metal for printing or other applications of the metal.

### BACKGROUND OF THE INVENTION

One significant topic in the thermal ink jet printing field is whether it can be used to print the nano-sized metal particles. Application of this technology can bring the ink jet printing into a broader market such as electronic equipment and optic materials manufacture. To reach this target, the first requirement is to make a stable aqueous based metal colloid dispersion.

Generally, two ways appear known to make the aqueous metal dispersions. The physical method is to directly disperse the metal in the presence of a dispersing agent with high energy. Another method also widely used is the chemical reduction method. It is well known that silver salts can be reduced to silver metal by chemical reducing reagents. Commonly used reducing reagents are borohydrides, citrate salts; ascorbic acid, hydrazine, glucose, hydrocarbons and hydrogen. Therefore, using this approach to prepare metal colloid in the aqueous medium has great convenience and advantage.

There are also many ways to prevent the metal colloid to agglomerate and precipitate. Commonly used are the stabilizers such as surfactants, polyelectrolytes, gelatin, polyphosphates, amino grafted polymer, or oligomer, dendrimer, crown ethers and amphiphilic polymer such as carboxymethyl cellulose sodium salt (CMC).

Previously reported literature for the chemical reduction include IS&T's NIP19 2003 International Conference on Digital Printing Technology, pages 656-659, by Nippon Paint; Chem. Mater., 2003, 15, pages 2208-2217 and J. Phys. Chem. 1982, 86, pages 3319-3395, and WO patent application 03/038002A1. Each method has its own advantages and disadvantages. For example, WO 03/038002A1 uses the CMC as the stabilizer and the citric acid presidium salt as the reducing reagent.

High molecular weight CMC could increase the viscosity of the dispersion. Carboxylic groups is not compatible with the silver salt in the reduction system, so the concentration of the silver and the number of the carboxylic groups are very sensitive in the reaction. This method introduces a large amount of salts into the system, which not only limits its selection of the stabilizing reagent, also final remove of the excess salt is required to render the system compatible with the ink jet printing. The reduction has to be finished at high temperature, also limited the equipment and increased the cost.

An industrial production system which is cheaper, better control of the metal particles size distribution, stability and readily adapted to inkjet and other printing applications is needed in the art.

### DISCLOSURE OF THE INVENTION

This invention employs the chemical reduction in an aqueous medium of a metal salt to the elementary metal colloid in the presence of a polymeric dispersant for the elementary metal colloid. The polymeric dispersants have ionic hydrophilic segments and nonionic hydrophilic segments. Such a dispersion is employed in aqueous inkjet inks having standard ingredients, particularly a humectant to reduce evaporation. The inks when printed on an absorptive substrate leave silver which is sintered by heat to a solid, conductive pattern.

### DESCRIPTION OF THE PREFERRED EMBODIMENTS

The polymeric dispersant may be somewhat made like dispersants which have been developed in recent years for the pigmented inks in inkjet. But there are also some fundamental differences. It is preferred that the dispersant is an acrylic polymer contains at least two major components: anionic segments and non-ionic segments. The anionic segments contains monomer having the carboxylic acid or sulfonic acid functional groups, which provides the electrostatic stability of the dispersion. The acid groups also provide the ability of interaction between silver and the polymer. The non-ionic segments are chosen from the hydroxy terminated polyethylene glycol monomers. It not only provides the steric stabilization, the hydrogen bonding interaction with the silver, but also give the solubility of the dispersion in the water/organic solvent therefore provides the ink printing reliability. It is also preferred that the PEG monomer has a molecular weight lower than 1000.

The polymer is a random co- or ter-polymer made through free radical polymerization. The molecular weight is controlled by a chain transfer reagent. Any kind of mercaptan compound can be used as the chain transfer reagent. Preferred chain transfer reagent in this reaction contains the hydroxy or acid functionality, such as 2-mercaptoethanol, 3-mercaptoethanol, mercaptoacetic acid, mercaptopropionic acid. 3-mercapto-1,2-propanediol.

The carboxylic acid content is very important in the dispersion. Too less will not provide the stability of the colloid preferred. Too much will also not compatible with the silver salt and result in large metal particle formation. The actual content can be judged in the reduction. Less than 50 wt % of acid is preferred, less than 20% of acid is more preferred.

The molecular weight is a not very important factor, and can be judged by the art in the term of dispersant and ink jet printing reliability. Too high molecular weight will increase the viscosity of the ink. But too low will not provide the stability of the dispersion also. Preferable from 8000 to 1000 by weight average molecular weight.

The reducing reagent used here is hydrazine. According to the general equation: 4Ag++N2H4—→4Ag+N2+4H+ (J. Appl. Polym. Sci. 1992, Vol. 44, pages 1003-1007 and Langmuir 2000, 16, pages 9087-9091) the reaction is very simple and can be completed at room temperature. The bi-product is a gas, which made the final product easy to be purified. Because of the existence of the stabilizer, the concentration of the silver can also be adjusted in the process.

It is believed the particle size of the silver colloid is controlled by several factors. First is the dispersant. The acid functions to interact and stabilize the silver colloid. But the quantity of the acid groups directly influence the solubility of the silver salt, and the solubility of the silver salt affects the particle size. The best quantity of the acid is that it will form a clear solution with the silver nitrate. If the clouds form, the particle size of the silver will be higher than expected. Second is the process. This reaction's bi-product is a gas. It generates foam in the reaction. Therefore, control the stirring speed, the addition speed and the ratio of the silver salt and the hydrazine is very important. It is preferred that the silver salt/dispersant solution and the hydrazine be dropped simultaneously to a dispersant solution. The dropping speed is silver salt faster than hydrazine. The last thing is the amount of the dispersant. Although it looked like the quantity of the dispersant is not very important in the particle size formation period, to maintain its stability through out the shelf life. Preferred ratio of dispersant to silver nitrate is 0.1 to 1 to 0.6 to 1 by weight. Most preferred is 0.2 to 1 by weight.

Some commercial polymers have the ability to disperse the silver colloid particles, such as polyacrylic acid. But, to reach the required particle size, the concentration, the required storage stability and the thermal ink print head reliability, this embodiment employs selected the monomer for this unique purpose. Generally speaking, a homopolymer of polyacrylic acid (PAA) produces larger size of silver colloid particles compared with co-polymer of this invention. The stability and printing reliability are also not as expected as the co-polymer. But it can be used as a co-stabilizer in the reaction system, its acid functionality can provide the buffer ability to the reaction system.

As illustrative of this invention, the random co-polymer of methacrylic acid and polyethylene glycol methacrylate (MAA/PEGMA); and co-polymer of MAA/Tris (polyethyleneglycol)2,4,6-tris 1-phenylethylphenylether methacrylate), are used here. Hydrazine monohydrate is used as the reducing agent.

The General Methods of Synthesis of the Co-Polymers are as Follows:

A mixture of polyethylene glycol methacrylate (mw360) 54 g and methacrylic acid 8 g, 3-mercapto-1,2-propanediol 2.0 g, iso-propanol 100 ml and V-601(dimethyl 2,2′-azobisisobutyrate) 0.2 g is mixed in a 300 ml three neck round bottom flask equipped with a mechanical stir, condenser and thermometer. The flask equipment is de-gassed, back filled with nitrogen and then heated to 75C in an oil bath for 18 hours. The solvent is then removed by evaporation and the mixture is neutralized with 20% KOH solution in De-ionized water. Final pH is 7.0.

The Reduction is Carried Out in the Following Methods:

1. Using Polymer Dispersant A

In a 200 ml flask, 50 ml of DI water and 0.2 g pure dispersant is mixed.

Prepare separately
1) 1 g silver nitrate in 50 ml DI water and 0.2 g dispersant. (assure it is a clear solution)
2) 0.4 g hydrazinemonohydrate (98%) in 50 ml DI water.
   Dropping 1 and 2 solution at the same time to the flask with good stirring. The dropping speed of silver nitrate is slightly faster than the hydrazine. Assure there is no foaming of the reaction. After addition of the silver nitrate, dropping of the hydrazine is continued while testing the completion of the reduction by using the ascorbic acid sodium salt solution until no black precipitate will be generated. At the point that the mixture does not generate black precipitate with the ascorbic acid, addition of the hydrazine solution can be stopped. The mixture is continued stirring for another hour, check the particle size by the MICROTRAC UPA 150 instrument. The particle size is about 16-40 nm. The final silver colloid is concentrated by ultra-filtration to the concentration of 10 to 30%.

2. Using polymer dispersant G and the method as described immediately above, except the amount of polymer dispersant with the silver nitrate is 0.06 g; the particle size is 22 nm.

3. Using polymer dispersant A and the method as described in 1) above, except the amount of the hydrazine is increased ⅓ to about 0.53 g; the particle size is 24 nm.

4. In a 200 ml flask, 50 ml of DI water, 0.1 g of PAA sodium salt and 0.13 g pure dispersant is mixed.

Prepare Separately
3) 1 g silver nitrate in 50 ml DI water and 0.13 g dispersant. (assure it is a clear solution)
4) 0.4 g hydrazinemonohydrate (98%) in 50 ml DI water.
   Dropping 1 and 2 solution at the same time to the flask with good stirring. The dropping speed of silver nitrate is slightly faster than the hydrazine. Assure there is no foaming of the reaction. After addition of the silver nitrate, dropping of the hydrazine is continued while testing the completion of the reduction by using the ascorbic acid sodium salt solution. At the end of the reaction the mixture does not generate black precipitate with the ascorbic acid. The mixture is continued stirring for another hour, check the particle size by the MICROTRAC UPA 150 instrument. The particle size is about 20-30 nm. The final silver colloid is concentrated by ultra-filtration to the concentration of 10 to 30%. (The PAA Mw can be from 1000 to 15,000. Prefer about 5000 to 8000)

Similar polymer solutions are made by the same method with the following formulation

| | A | B | C | D | E | F | G |
|---|---|---|---|---|---|---|---|
| PEGMA(360) | 54 | 43 | | 25 | 43 | | 54 |
| PEGMA(526) | | | 25 | | | | |
| Tris | | | | | | 50 | |
| MAA | 13 | 21 | 43 | 43 | 21 | 25 | 8 |
| 3-mercapto- | 3.6 | 3 | 2 | 2 | 1.5 | 1.1 | 2.0 |
| 1,2propandiol | | | | | | | |
| Particle Size(nm) | 15-25 | 28 | 106 | 245 | 125 | * | 22 |

*high viscosity

An illustrative ink formulation used for printing is as follows: The particle size of the silver is preferred between 10 to 30 nm.
68 g of the silver colloid dispersion made from polymer dispersant A
4.3 g glycerol
4.3 g 2-pyrrolidone
0.2 g SURFANOL 465 (an acetylene surfactant from Air Product)
   Silver content of this ink is 13.5% by Inductive Coupled Plasma (ICP) measurement. Particle size is 16 nm; viscosity is 2.2 cp; pH is adjusted with a base to 6.0.

Printing may be on the coated surface of commercially available papers for inkjet printing. These papers typically have gelatin or porous ceramic coating to receive ink. The sintering temperatures do not destroy these paper so the resulting paper is suitable as an electrical element to be covered in a limitation or otherwise encased.

Printing with this illustrative ink on water absorptive substrate, followed by sintering under heat, produced electrical conductive patterns. Process can be variable, include print pass (i.e., how many 600 dpi layers are laid on the media), print mode (full density vs. shingling mode), sinter temperature and sinter time. For full density print pattern, 600 dpi ink drop will be laid down after one swath. For shingling print pattern, it needs two repeat swathes to get 600 dpi ink drop density. The result indicates that the best performance of the described ink has a sheet resistance 0.16 ω/.

Although described with specific embodiment of silver, other metals can similarly be reduced and therefore the invention extends to metals in general.

What is claimed is:

1. A method of forming a metal dispersion comprising:
reducing a metal compound with an aqueous soluble reducing reagent in an aqueous medium in the presence of a polymeric dispersant comprising, ionic, hydrophilic segments and, nonionic, hydrophilic segments.

2. The method as in claim 1 in which said metal is silver.

3. The method as in claim 1 in which said ionic hydrophilic segments of said dispersant contains carboxylic acid functional groups.

4. The method as in claim 1 in which said nonionic hydrophilic segments of said dispersant contains hydroxy terminated polyethylene glycol functional groups.

5. The method as in claim 4 in which said ionic hydrophilic segments of said dispersant contains carboxylic acid functional groups.

6. The method as in claim 2 in which said ionic hydrophilic segments of said dispersant contains carboxylic acid functional groups.

7. The method as in claim 2 in which said nonionic hydrophilic segments of said dispersant contains hydroxy terminated polyethylene glycol functional groups.

8. The method as in claim 7 in which said ionic hydrophilic segments of said dispersant contain carboxylic acid functional groups.

9. The method as in claim 8 in which the ratio of said dispersant to the silver metal compound is 0.1 to 1 by weight.

10. An inkjet ink comprising a humectant and silver dispersed in an aqueous vehicle by a polymeric dispersant comprising, ionic hydrophilic segments and, nonionic functional segments.

11. The ink as in claim 10 in which said ionic hydrophilic segments of said dispersant contains carboxylic acid functional groups.

12. The ink as in claim 10 in which said nonionic functional segments of said dispersant contain hydroxyl terminated polyethylene glycol functional groups.

13. The ink as in claim 12 in which said ionic hydrophilic segments of said dispersant contains carboxylic acid functional groups.

14. The method of printing metal patterns on absorptive substrates comprising printing a pattern on an absorptive substrate using the ink of claim 10 and then sintering the silver applied by said printing by heat.

15. The method of printing metal patterns on absorptive substrates comprising printing a pattern on an absorptive substrate using the ink of claim 11 and then sintering the silver applied by said printing by heat.

16. The method of printing metal patterns on absorptive substrates comprising printing a pattern on an absorptive substrate using the ink of claim 12 and then sintering the silver applied by said printing by heat.

17. The method of printing metal patterns on absorptive substrates comprising printing a pattern of an absorptive substrate using the ink or claim 13 and then sintering the silver applied by said printing by heat.
